(19) United States
(12) Patent Application Publication
(10) Pub. No.: US 2004/0153611 A1
(43) Pub. Date: Aug. 5, 2004

(54) Methods and apparatus for detecting an address conflict

(76) Inventors: Sujat Jamil, Chandler, AZ (US); Hang Nguyen, Tempe, AZ (US); Quinn Merrell, Fort Collins, CO (US); Samantha J. Edirisooriya, Tempe, AZ (US); David E. Miner, Chandler, AZ (US); R. Frank O'Bleness, Tempe, AZ (US); Steven J. Tu, Phoenix, AZ (US)

Correspondence Address: GROSSMAN & FLIGHT LLC, Suite 4220, 20 North Wacker Drive, Chicago, IL, 60606-6357, US

(21) Appl. No.: 10/357,780

(22) Filed: Feb. 4, 2003

(51) Int. Cl. G06F 12/00

(52) U.S. Cl. 711/145; 711/144; 711/210

(57) ABSTRACT

Methods and apparatus to detect memory address conflicts are disclosed. When a new cache line is allocated, the cache places the location where the cache line will be placed in a “pending” state until the cache line is retrieved. If a subsequent memory request is looking for an address in the pending cache line, that request is held back (e.g., delayed or replayed), until the cache line fill is complete and the “pending” status is removed. In this manner, the “pending” state, typically used to reserve cache locations, is also used to detect address conflicts.

### TECHNICAL FIELD

The present invention relates in general to cache memory and, in particular, to methods and apparatus for detecting an address conflict.

### BACKGROUND

In an effort to increase computational speed, many computing systems are turning to multi-processor systems. A multi-processor system typically includes a plurality of processors or processing cores, one or more caches, and a main memory. In an effort to further increase computational speed, many multi-processor systems use pipelined and/or non-blocking caches. Pipelined caches allow memory operations spanning multiple cycles to overlap. Non-blocking caches allow additional memory requests to be serviced by a cache while the cache is retrieving memory from another level of cache and/or main memory (e.g., due to a previous “miss”).

To maintain program correctness, these non-blocking caches must honor data dependencies. Specifically, a subsequent access to a memory location which already has an earlier request outstanding needs to see the effect of the earlier request. For example, a write operation to a memory location must appear to complete before a subsequent read operation from the same memory location is allowed to proceed. Typically, these data dependencies are honored (i.e., address conflicts avoided) by comparing addresses of new memory requests to a list of addresses associated with outstanding memory requests. A match indicates a data dependency exits. If a data dependency is found, the subsequent memory operation is stalled or replayed to allow the earlier operation to complete.

In order to facilitate this address conflicts check, a content addressable memory (CAM) is typically used. A CAM is a memory that is queried with a data value that the memory may contain (in this case an address associated with an outstanding memory request), rather than being queried by a traditional memory address. A CAM is an associative memory device which includes comparison logic for each memory location. A CAM is read by broadcasting a data value to all memory locations of the CAM simultaneously. In parallel, each portion of the comparison logic then determines if the broadcast data value is stored in the memory location associated with that comparison logic. Memory locations with matches are flagged, and subsequent operations can work on the flagged memory locations. For example, a flagged memory location may be read out of the CAM.

However, CAMs tend to be slow, especially if a large number of values representing outstanding memory requests are stored in the CAM. As a result, CAM operations are often a bottleneck in high clock frequency designs. In addition, CAMs tend to be large, thereby consuming processing resources such as die area, power, and routing.

### BRIEF DESCRIPTION OF THE DRAWINGS

FIG. 1 is a block diagram of a computer system illustrating an environment of use for the disclosed system.

FIG. 2 is a more detailed block diagram of the multi-processor illustrated in FIG. 1.

FIG. 3 is a block diagram of an example memory hierarchy.

FIG. 4 is a flowchart of a process for detecting an address conflict.

### DETAILED DESCRIPTION

In general, the methods and apparatus described herein detect memory address conflicts by using a “pending” state maintained by the cache without the use of a CAM structure. As a result, CAM lookup latency is eliminated. In addition, hardware resources previously used by the CAM structure (and associated request tracking control) such as die area, power, and routing may be eliminated and/or used to implement other circuitry. When a new cache line (i.e., cache memory block) is allocated, the cache places the location where the cache line will be placed in the “pending” state until the cache line is retrieved from another level of cache or main memory. If a subsequent memory request is looking for an address in the pending cache line, that request is held back (e.g., delayed or replayed), until the cache line fill is complete and the “pending” status is removed. In this manner, the “pending” state, typically used to reserve cache locations, is also used to detect address conflicts.

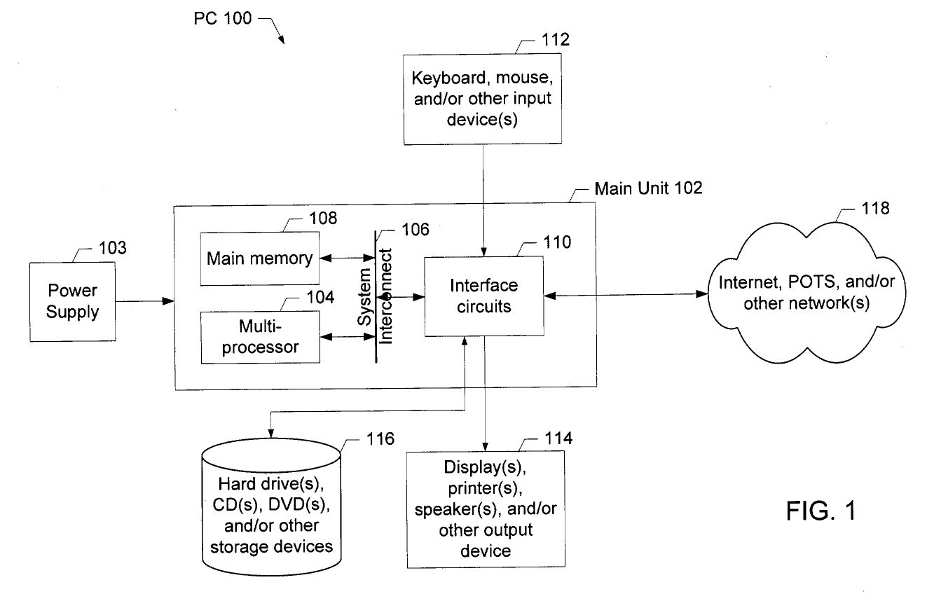

A block diagram of a computer system 100 is illustrated in FIG. 1. The computer system 100 may be a personal computer (PC), a personal digital assistant (PDA), an Internet appliance, a cellular telephone, or any other computing device. In one example, the computer system 100 includes a main processing unit 102 powered by a power supply 103. The main processing unit 102 may include a multi-processor unit 104 electrically coupled by a system interconnect 106 to a main memory device 108 and to one or more interface circuits 110. In one example, the system interconnect 106 is an address/data bus. Of course, a person of ordinary skill in the art will readily appreciate that interconnects other than busses may be used to connect the multi-processor unit 104 to the main memory device 108. For example, one or more dedicated lines and/or a crossbar may be used to connect the multi-processor unit 104 to the main memory device 108.

The multi-processor 104 may include any type of well known processor, such as a processor from the Intel Pentium® family of microprocessors, the Intel Itanium® family of microprocessors, and/or the Intel XScale® family of processors. In addition, the multi-processor 104 may include any type of well known cache memory, such as static random access memory (SRAM). The main memory device 108 may include dynamic random access memory (DRAM) and/or any other form of random access memory. For example, the main memory device 108 may include double data rate random access memory (DDRAM). The main memory device 108 may also include non-volatile memory. In one example, the main memory device 108 stores a software program which is executed by the multi-processor 104 in a well known manner.

The interface circuit(s) 110 may be implemented using any type of well known interface standard, such as an Ethernet interface and/or a Universal Serial Bus (USB) interface. One or more input devices 112 may be connected to the interface circuits 110 for entering data and commands into the main processing unit 102. For example, an input device 112 may be a keyboard, mouse, touch screen, track pad, track ball, isopoint, and/or a voice recognition system.

One or more displays, printers, speakers, and/or other output devices 114 may also be connected to the main processing unit 102 via one or more of the interface circuits 110. The display 114 may be a cathode ray tube (CRT), a liquid crystal displays (LCD), or any other type of display. The display 114 may generate visual indications of data generated during operation of the main processing unit 102. The visual indications may include prompts for human operator input, calculated values, detected data, etc.

The computer system 100 may also include one or more storage devices 116. For example, the computer system 100 may include one or more hard drives, a compact disk (CD) drive, a digital versatile disk drive (DVD), and/or other computer media input/output (I/O) devices.

The computer system 100 may also exchange data with other devices via a connection to a network 118. The network connection may be any type of network connection, such as an Ethernet connection, digital subscriber line (DSL), telephone line, coaxial cable, etc. The network 118 may be any type of network, such as the Internet, a telephone network, a cable network, and/or a wireless network.

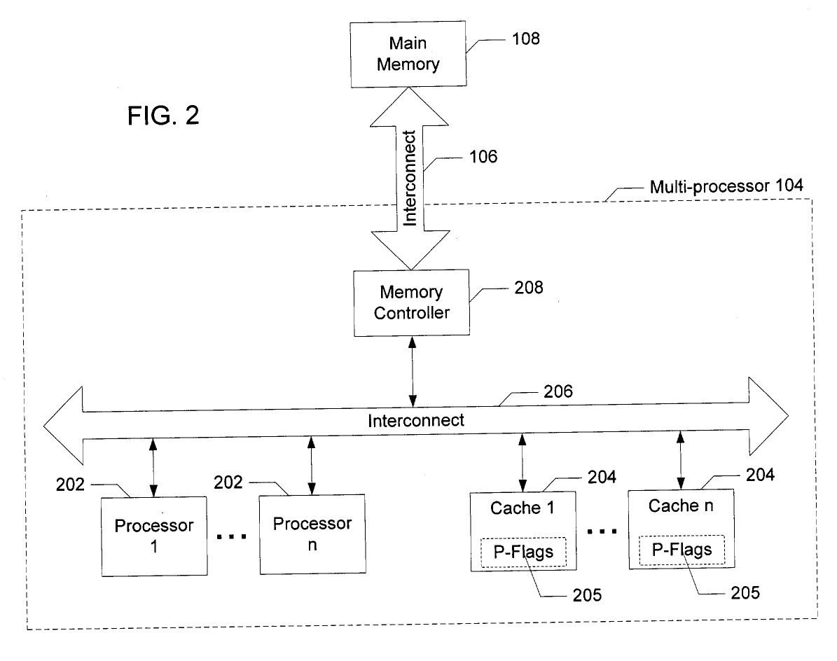

A more detailed block diagram of the multi-processor unit 104 is illustrated in FIG. 2. The multi-processor 104 shown includes one or more processing cores 202 and one or more caches 204 electrically coupled by an interconnect 206. The processor(s) 202 and/or the cache(s) 204 communicate with the main memory 108 over the system interconnect 106 via a memory controller 208.

Each processor 202 may be implemented by any type of processor, such as an Intel XScale® processor. Each cache 204 may be constructed using any type of memory, such as static random access memory (SRAM). Preferably, each cache 204 includes a set of pending flags 205. The pending flags 205 indicate if an associated cache line is waiting to be filled. The interconnect 206 may be any type of interconnect such as a bus, one or more dedicated lines, and/or a crossbar. Each of the components of the multi-processor 104 may be on the same chip or on separate chips. For example, the main memory 108 may reside on a separate chip. Typically, if activity on the system interconnect 106 is reduced, power consumption is reduced. This is especially true in a system where the main memory 108 resides on a separate chip.

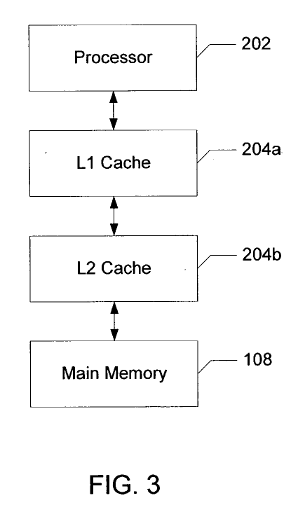

A block diagram of an example memory hierarchy is illustrated in FIG. 3. Typically, memory elements (e.g., registers, caches, main memory, etc.) that are closer to the processor 202 are faster than memory elements that are farther from the processor 202. As a result, closer memory elements are used for potentially frequent operations and are checked first. Closer memory elements are typically constructed using faster memory technologies. However, faster memory technologies are typically more expensive than slower memory technologies. Accordingly, close memory elements are typically smaller than distant memory elements. Although three levels of memory are shown in FIG. 3, persons of ordinary skill in the art will readily appreciate that more or fewer levels of memory may alternatively be used.

In the example illustrated, when a processor 202 executes a memory operation (e.g., a read or a write), the request is first passed to a level one cache 204a which is typically internal to the processor 202, but may optionally be external to the processor 202. If the level one cache 204a holds the requested memory in a state that is compatible with the memory request (e.g., a write request is made and the level one cache holds the memory in an “exclusive” state), the level one cache 204a fulfills the memory request (i.e., an L1 cache hit). If the level one cache 204a does not hold the requested memory, the memory request is passed on to a level two cache 204b which is typically external to the processor 202, but may optionally be internal to the processor 202 (i.e., an L1 cache miss).

Like the level one cache, if the level two cache 204b holds the requested memory in a state that is compatible with the memory request, the level two cache 204b fulfills the memory request (i.e., an L2 cache hit). In addition, the requested memory may be moved up from the level two cache 204b to the level one cache 204a. If the level two cache 204b does not hold the requested memory, the memory request is passed on to the main memory 108 (i.e., an L2 cache miss).

If the memory request is passed on to the main memory 108, the main memory 108 fulfills the memory request. In addition, the requested memory may be moved up from the main memory 108 to the level two cache 204b and/or the level one cache 204a. If the cache 204a is a non-blocking cache, additional memory requests may be serviced by the cache 204a while the cache 204a is retrieving memory from another level of cache 204b and/or main memory 108. In such an instance, address conflicts must be avoided to honor data dependencies and maintain program correctness.

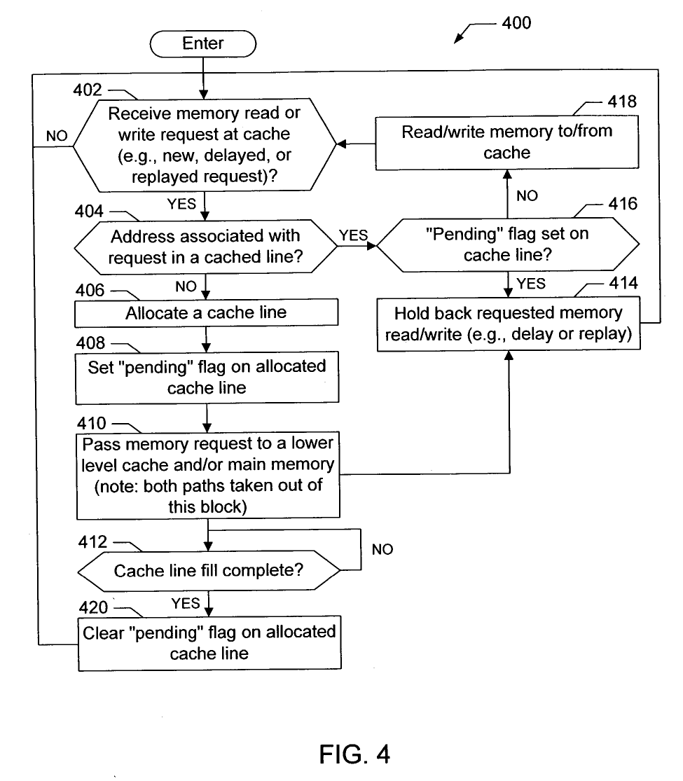

A flowchart of a process 400 for detecting an address conflict is illustrated in FIG. 4. Although the process 400 is described with reference to the flowchart illustrated in FIG. 4, a person of ordinary skill in the art will readily appreciate that many other methods of performing the acts associated with process 400 may be used. For example, the order of many of the blocks may be changed, and/or the blocks themselves may be changed, combined and/or eliminated.

Generally, when a new cache line is allocated, the cache places the location where the cache line will be placed in a “pending” state until the cache line is retrieved. If a subsequent memory request is looking for an address in the pending cache line (not necessarily the exact same address that caused the entire cache line to be allocated), that request is held back until the cache line fill is complete and the “pending” status is removed. In this manner, the “pending” state, typically used to reserve cache locations, is also used to detect address conflicts.

The process 400 begins when a cache 204 receives a memory request (block 402). The memory request may be a memory read operation or a memory write operation. Avoiding address conflicts associated with memory write operations maintains program correctness. Avoiding address conflicts associated with memory read operations increases the number of cache hits, which increases computational efficiency and may reduce power consumption. The memory request may be a new memory operation generated by a processor 202, or the memory request may be a previously generated memory operation that was held back due to a memory address conflict. Memory operations may be held back by delaying the memory request for a period of time and/or replaying the memory operation.

When a cache 204 receives the memory request, the cache 204 determines if the address associated with the memory request is represented in a cache line that is currently stored in the cache 204 (block 404). Typically, the cache 204 determines if the address associated with the memory request is represented in a cache line that is currently stored in the cache 204 by checking one or more address tags stored in the cache 204. If the address associated with the memory request is not represented in a cache line that is currently stored in the cache 204, the cache 204 allocates a new cache line to hold the requested memory by setting the appropriate address tags (block 406). If an existing cache line needs to be replaced to allocate the new cache line, any well known cache replacement strategy may be used. For example, a least recently used (LRU) cache replacement strategy may be used.

The cache 204 then places the allocated cache line in a “pending” state (block 408). The cache line may be placed in the pending state by setting a “pending” flag associated with the cache line or by any other state indication method. For example, a group of bits (e.g., a nibble or a byte) may be used to indicate a plurality of states associated with the cache line. This group of bits may be set to a predetermined value to indicate that the cache line is in the pending state.

The cache 204 then attempts to fill the allocated cache line by passing the memory request to another level of cache 204 and/or main memory 108 (block 410). The cache 204 then waits for the cache line fill to complete (block 412). However, if the cache 204 is a non-blocking cache, additional memory requests may be serviced while the cache 204 is waiting for the cache line to fill. Accordingly, the current memory request is held back (block 414). The current memory request may be held back in any known manner such as by delaying or replaying the memory request.

When the held back memory request is received by the cache 204 (block 402), the cache 204 again determines if the address associated with the memory request is represented in a cache line (block 404). This time, the address is represented in the cache 204 due to the earlier allocation by block 406. As a result, the cache 204 also determines if the allocated cache line is in the pending state (block 416). The state of the cache line may be determined in any well known manner. For example, a pending flag or state byte may be checked. If the cache line is still pending (i.e., the cache line fill is not complete as tested by block 412), the memory request is held back again.

If a subsequent memory request is generated, the same process 400 is followed even if one or more other cache lines are in the pending state. For example, another processor 202 or another processing thread may generate a memory read or write operation at the cache 204. In such an instance, the cache 204 receives the memory request (block 402) and determines if the address associated with the memory request is represented in a cache line that is currently stored in the cache 204 (block 404). If the address associated with the memory request is not represented in a cache line that is currently stored in the cache 204 (block 404), the cache 204 allocates a new cache line to hold the requested memory (block 406) and places the newly allocated cache line in the “pending” state (block 408). However, if the address associated with the memory request is represented in a cache line that is currently stored in the cache 204 (block 404) and that cache line is not “pending” (block 416), the memory operation is executed (block 418). For example, the memory location is written to, or read from, the cache 204.

Once the cache line fill completes (block 412), the allocated cache line is transitioned out of the “pending” state (block 420). The allocated cache line may be transitioned out of the “pending” state by clearing a flag or changing the value of a group of bits. Subsequently, memory requests (new or held back) received by the cache 204 (block 402) that are associated with addresses in the cache line may read and/or write to/from the cache line (block 418), because the cache line is no longer pending (block 416).

In summary, persons of ordinary skill in the art will readily appreciate that methods and apparatus for detecting address conflicts have been provided. The foregoing description has been presented for the purposes of illustration and description. It is not intended to be exhaustive or to limit the scope of this patent to the examples disclosed. Many modifications and variations are possible in light of the above teachings. It is intended that the scope of this patent be defined by the claims appended hereto as reasonably interpreted literally and under the doctrine of equivalents.

What is claimed is:

1. A method of detecting an address conflict, the method comprising:
receiving a first memory access request that misses a cache;
allocating a cache line in a pending state in response to the first memory access request;
receiving a second memory access request that hits the cache line; and
holding back the second memory access request if the cache line is in the pending state.

2. A method as defined in claim 1, wherein holding back the second memory access comprises holding back the second memory access until a line fill associated with the cache line in the pending state completes and the cache line is transitioned from the pending state.

3. A method as defined in claim 1, wherein holding back the second memory access comprises stalling the second memory access.

4. A method as defined in claim 3, wherein stalling the second memory access is in response to receiving the second memory access request that hits the cache line in the pending state.

5. A method as defined in claim 1, wherein holding back the second memory access comprises replaying the second memory access.

6. A method as defined in claim 5, wherein replaying the second memory access is in response to receiving the second memory access request that hits the cache line in the pending state.

7. A method as defined in claim 1, wherein allocating a cache line in a pending state prevents the cache line from being reallocated until the line fill associated with the cache line completes and the cache line is transitioned from the pending state.

8. A method as defined in claim 1, further comprising:
receiving a third memory access request that hits the cache line after the cache line is transitioned from the pending state; and
completing the third memory access request in response to receiving the third memory access request.

9. A method as defined in claim 1, further comprising:
receiving a third memory access request that misses the cache line in the pending state; and
completing the third memory access request in response to
completing the third memory access request in response to receiving the third memory access request.

10. A method as defined in claim 1, wherein allocating a cache line in a pending state comprises asserting a flag in a cache memory device.

11. A method as defined in claim 1, wherein the first memory access request comprises a memory write operation and the second memory access request comprises a memory read operation.

12. A method as defined in claim 1, wherein the first memory access request comprises a first memory read operation and the second memory access request comprises a second memory read operation.

13. A computing device comprising:
a processor;
a memory controller coupled to the processor; and
a cache coupled to the processor, the cache including a pending status field, the cache to receive a first memory request from the processor, the memory request to miss the cache, the cache to allocate a cache line in a pending state using the pending status field, the cache to receive a second memory request, the second memory request to hit the cache line in the pending state, and the cache to hold back the second memory request until the cache line is transitioned from the pending state.

14. A computing device as defined in claim 13, wherein the cache holds back the second memory request by stalling the second memory access.

15. A computing device as defined in claim 13, wherein the cache holds back the second memory request by replaying the second memory access.

16. A computing device as defined in claim 13, wherein allocating the cache line in the pending state prevents the cache line from being reallocated until the cache line is transitioned from the pending state.

17. A computing device as defined in claim 13, wherein the cache:
receives a third memory request that hits the cache line after the cache line is transitioned from the pending state; and
completes the third memory request in response to receiving the third memory access request.

18. A computing device as defined in claim 13, wherein the cache:
receives a third memory request that misses the cache line in the pending state; and
completes the third memory request in response to receiving the third memory request.

19. A computing device as defined in claim 13, wherein the processor comprises a first core and the computing device further includes a second core coupled to the cache, wherein the first core and the second core share the cache.

20. A computing device as defined in claim 19, wherein the first memory request comes from the first core and the second memory request comes from the second core.

21. A computing device as defined in claim 13, wherein the cache comprises a pipelined cache.

22. A computing device as defined in claim 13, wherein the cache comprises a non-blocking cache.

23. A computing device as defined in claim 22, wherein the cache comprises a pipelined cache.

24. A computing device as defined in claim 13, wherein a content addressable memory (CAM) is not used to detect an address conflict.

25. A computing device as defined in claim 13, wherein request tracking control circuitry associated with a content addressable memory (CAM) is not used.

26. A computing device as defined in claim 13, wherein allocating a cache line in a pending state comprises asserting a flag in the cache.

27. A method of detecting an address conflict, the method comprising:
receiving a first memory access request that misses a cache;
allocating a cache line in response to the first memory access request;
setting a pending flag associated with the allocated cache line, the pending flag being internal to the cache;
receiving a second memory access request that hits the cache line while the pending flag is set;
determining that the pending flag is set; and
holding back the second memory access request in response to determining that the pending flag is set.

28. A method as defined in claim 27, wherein holding back the second memory access comprises at least one of stalling the second memory access and replaying the second memory access.

29. A method as defined in claim 27, further comprising clearing the pending flag associated with the allocated cache line when the cache line is filled.
